(19) United States
(12) Patent Application Publication
(10) Pub. No.: US 2010/0058925 A1
(43) Pub. Date: Mar. 11, 2010

(54) CAPTURE OF TOXINS AND ENVIRONMENTAL CONTAMINANTS

(76) Inventor: Paul James Byrne, Queensland (AU)

Correspondence Address: AUSTIN RAPP & HARDMAN, 170 South Main Street, Suite 735, SALT LAKE CITY, UT, 84101, US

(21) Appl. No.: 11/917,376

(22) PCT Filed: Jun. 14, 2006
(86) PCT No.: PCT/AU2006/000820

§ 371 Date: Nov. 18, 2009

(30) Foreign Application Priority Data
Jun. 14, 2005 (AU) 2005903078

(51) Int. Cl. B01D 53/72; A24D 3/06; F01N 3/021; B01D 53/34; F24F 3/16; B01D 53/92; A62B 23/02; B01D 53/02

(52) U.S. Cl. 95/141; 131/331; 96/108; 96/154; 128/205.27

(57) ABSTRACT

A filter material for removing toxins and/or environmental contaminants from a body of gas, comprising bentonite disposed within a support arranged so as to allow contact between the body of gas and the bentonite.

### TECHNICAL FIELD

The present invention is concerned with the removal of potentially toxic chemicals and environmental contaminants particularly those produced or volatilised during combustion. The invention is particularly applicable to smoke from combustion of any material including factory emissions, automobile exhaust gases and the like, as well as smoke generated through the combustion of tobacco. For the sake of convenience the invention will be described primarily with reference to filter materials for tobacco smoke for use in conjunction with or as a part of a cigarette, cigar or tobacco pipe or other smoking implement. Nevertheless, it is envisaged that the materials of the present invention may be used in conjunction with air-conditioning systems or the like to remove volatile organic contaminants from a room or building, as a component of gas masks to filter toxins to counter terrorism, for use in the vicinity of fires and/or in cities with persistent atmospheric contamination as a filter in a smoke stack or elsewhere in an industrial process, as a part of an automobile exhaust system to reduce toxic emissions, and other such applications. Furthermore, incorporation into air sampling devices, capture of volatiles for analysis, and other applications not directly concerned with removal of toxins and/or environmental contaminants are envisaged.

### BACKGROUND ART

As reported by the International Agency for Research on Cancer (IARC), 44 individual chemical agents found in cigarette smoke are classified as “Group I carcinogens”. The nine main chemical agents reported include both metals and organic compounds (beryllium cadmium, arsenic, nickel, chromium, 2-naphthylamine, vinyl chloride, 4-aminobiphenyl, and benzene). Their concentration in mainstream smoke varies, depending on the type of cigarette (Smith et al., 1997). The introduction of filter tips, with and without perforation in the 1950's, and the utilisation of highly porous cigarette papers has seen a significant reduction in the inhalation of carcinogens from cigarette smoke. However, many of these conventional cigarette filters do not retain some chemical agents (Deliconstantinos et al., 1994).

Thus, there remains a need for more effective filters for removing potentially toxic chemicals generated during smoking, in particular the carcinogens, from cigarette smoke.

### SUMMARY OF THE INVENTION

According to a first aspect of the present invention there is provided a filter material for removing toxins and/or environmental contaminants from a body of gas, comprising bentonite disposed within a support arranged so as to allow contact between the body of gas and the bentonite.

According to a second aspect of the present invention there is provided a method of removing toxins and/or environmental contaminants from a body of gas comprising contacting the body of gas with bentonite.

According to a third aspect of the present invention there is provided, the use of bentonite to remove toxins and/or organic contaminants from a body of gas.

The bentonite may constitute the filter material together with a discrete support, or may form a part of a filter material. The filter material may be a conventional filter material, such as the fibrous cellulose acetate filters conventionally used in cigarettes, but it may also form a part of other polymeric matrices or materials useful as filters for a gas stream passing therethrough such as gas permeable membrane disposed across a conduit or channel.

Any means of encapsulating bentonite within a filter material may be employed. Where the bentonite is used to filter potentially toxic chemicals from the cigarette smoke, for example, the bentonite may be dispersed within a polymeric matrix in comminuted, granular and/or powdered form or may form discrete regions within such a matrix. Particularly, in the case of tobacco smoke, the matrix may be encapsulated by paper or other inert support, which may be porous or impervious to smoke as is well known to the person skilled in the art. Alternatively, there may be discrete regions of bentonite encapsulated within the paper. There may be one or several such zones, and these may alternate with regions of conventional filter or regions in which bentonite is dispersed within a conventional filter.

In an embodiment there is provided a tobacco smoke filter for use in a cigarette, cigar or tobacco pipe comprising bentonite arranged so that tobacco smoke generated in smoking the cigarette, cigar or tobacco pipe is filtered through the bentonite prior to inhalation.

This embodiment also provides a tobacco pipe, cigarette or cigar having a tobacco smoke filter comprising bentonite, wherein the tobacco smoke filter is arranged so that tobacco smoke generated in smoking the cigarette, cigar or tobacco pipe is filtered through the bentonite prior to inhalation.

The conventional form which cigarettes, cigars and tobacco pipes take is well known to the person skilled in the art. The conventional arrangement for filter and tobacco in cigarettes is to have a paper surrounding a tobacco-containing portion at an end distal to the smoker's mouth adjacent a filter proximal the smoker's mouth, at least where a filter is present. It is envisaged that such conventional arrangements may be employed in the present invention, but also any other arrangement whereby the bentonite serves to filter tobacco smoke generated in the smoking process. A filter in accordance with the invention may be interpolated within a tobacco pipe. Bentonite may also be introduced to the tobacco, for example the portion proximal to smoker's mouth in a cigar, if desired.

In an alternative embodiment there is provided a filter system for filtering toxins and/or environmental contaminants from a body of gas disposed within a space, comprising bentonite disposed so that a gas stream circulating within or recirculating to the space passes therethrough.

In particular, this embodiment of the invention envisages a filtration system placed in an air-conditioning unit or duct or the like, whereby the potentially toxic chemicals contained in cigarette smoke and any other smoke generated within the air-conditioned area may be progressively filtered from the air in that area as it is recycled through the air-conditioning system. Thus, the level of potentially toxic chemicals in the air may be reduced even in environments where there are many smokers. Therefore, the amount of potentially toxic chemicals which are inhaled by those present who are not smoking may be reduced. Equally, the body of gas could be captured by an air sampling device for analysis.

In a further embodiment there is provided a filter system for filtering toxins from smoke generated in a combustion chamber comprising disposing bentonite so that gases produced in the combustion chamber contact the bentonite as they are exhausted.

In one form of the invention the bentonite may contact smoke exhausted through a stack. Alternatively, it could form a part of an automobile exhaust or a gas mask.

Typically the bentonite may be incorporated in a filtration system such as HEPA filter (an acrylate-capped polyoxyethylene polymer) or other conventional filter for such systems. Alternatively, the gas stream may pass through a large mass of bentonite disposed within an appropriate container or held in place by a support.

The bentonite of the invention is preferably a calcium bentonite.

The bentonite may be modified by a chemical or physical treatment or may be unmodified. Unmodified bentonite, which is predominantly a smectitic clay has a negative surface. There may be a combination of modified and unmodified bentonite used in the invention. The surface of bentonite particles may be modified by introducing one or more surface active agents. Bentonite may be modified, for example, by introducing one or more surfactants, in particular cationic surfactants, to decrease its hydrophilicity. Typically a quaternary ammonium surfactant of general formula (CH₃)₃NR⁺ such as cetyltrimethyl bromide (CTAB) or cetyltrimethyl ammonium tosylate (TTAB) may be used to modify bentonite to this end.

### BRIEF DESCRIPTION OF THE DRAWINGS

Embodiments of the present invention will now be described, by way of example only, with reference to the accompanying drawings, in which:

FIG. 1 shows differences in discoloration of bentonite (B) and modified bentonite (C and D) filters after smoking 1 cigarette compared to a blank bentonite filter (ie. no cigarette smoke has passed through the filter) (A);

FIG. 2 shows a GC/MS chromatogram of a hexane eluted sorbent (bentonite clay) not subjected to the passage of cigarette smoke (FIG. 1A);

FIG. 3 shows a GC/MS chromatogram of hexane eluted commercial filter subjected to the passage of cigarette smoke;

FIGS. 3a-d give a comparison of sample MS spectral fragmentation patterns (upper spectra) with those of the spectral reference library (lower spectra) for (a) toluene, (b) 4,-cycloclopentene-1,3-dione, (c) phenol and (d) nicotine for a conventionally available filter;

FIG. 4 shows a GC/MS chromatogram of a hexane eluted unmodified bentonite filter subjected to the passage of cigarette smoke;

FIGS. 4a-f give a comparison of sample MS spectral fragmentation patterns (upper spectra) with those of the spectral reference library (lower spectra) for (a) ethylbenzene, (b) p-xylene, (c) benzene, (d) o-cresol, (e) naphthalene and (f) nicotine for an unmodified bentonite filter;

FIG. 5 shows a GC/MS chromatogram of a hexane eluted bentonite filter modified with CTAB and subjected to the passage of cigarette smoke;

FIG. 6 shows a GC/MS chromatogram of a hexane eluted bentonite filter modified with TTAB and subjected to the passage of cigarette smoke;

FIG. 7 is a partial cut-away view of a cigarette in accordance with embodiments of the present invention comprising a filter material with bentonite disposed therein;

FIG. 8 is a front view of a gas mask in accordance with embodiments of the present invention comprising a filter material with bentonite disposed therein;

FIG. 9 is a perspective view of an automobile exhaust in accordance with embodiments of the present invention comprising a filter material with bentonite disposed therein;

FIG. 10 is a perspective view of an air conditioning unit in accordance with embodiments of the present invention comprising a filter material with bentonite disposed therein; and

FIG. 11 is a perspective view of an exhaust stack in accordance with embodiments of the present invention comprising a filter material with bentonite disposed therein.

### DETAILED DESCRIPTION OF EMBODIMENTS

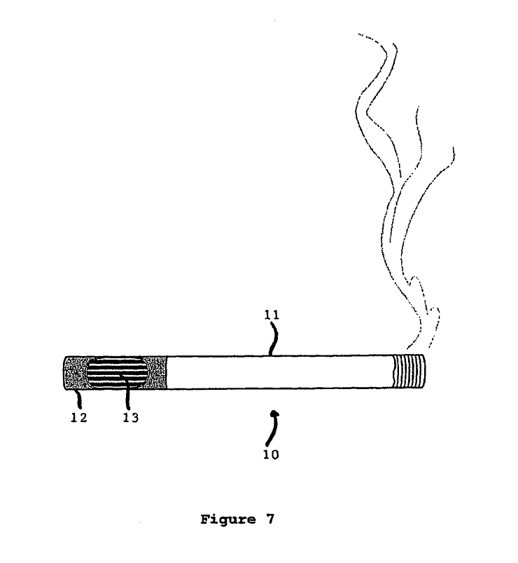

Referring firstly to FIG. 7, a cigarette 10 according to embodiments of the present invention is shown. The cigarette 10 comprises a tobacco portion 11 in which tobacco and conventional additives are wrapped in a filter paper, which also encircles a filter material 12. The filter material 12 in this instance contains particles of bentonite disposed therein. The dispersion of the bentonite particles may be broadly uniform, or may be concentrated in portions of the filter material 12. The bentonite is typically a calcium bentonite. The bentonite may be unmodified, or may be modified by physical treatment or by chemical treatment with organic chemicals such as CTAB or TTAB. Other surface active agents or surfactants, in particular cationic surfactants may be used to modify the bentonite. The bentonite is disposed within a support 13 arranged so as to allow contact between the body of gas and the bentonite. The support 13 may be conventional, or may be treated in order to ensure compatibility with the bentonite particles disposed therein. The filter material 12 may contain conventional additives and will be manufactured in a conventional manner save for the addition of bentonite particles.

In an embodiment the calcium bentonite particles may be arranged in zones within the filter material 12. The filter material 12 may either comprise separate structures divided by the bentonite zones, or may comprise the zones of bentonite particles dispersed within a unitary structure. In the former case, the separate structures may be secured in position by any convenient means, and the bentonite particles may either be free or dispersed in a matrix, provided that the matrix does not have a significant adverse effect on the ability of the bentonite to absorb potentially toxic chemicals from cigarette smoke.

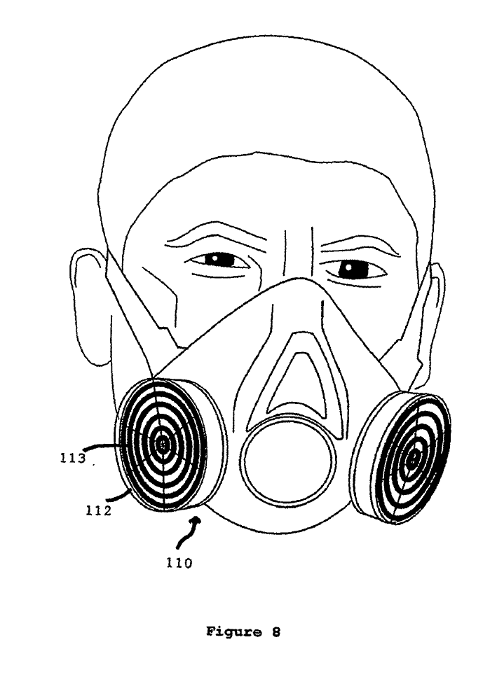

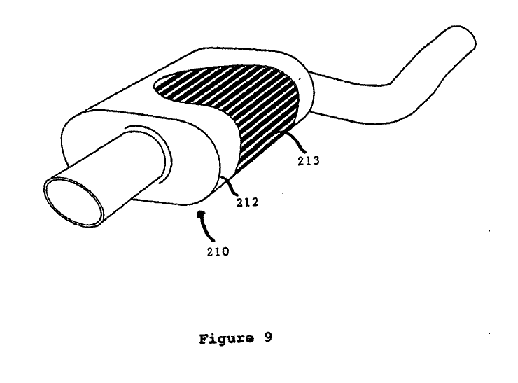

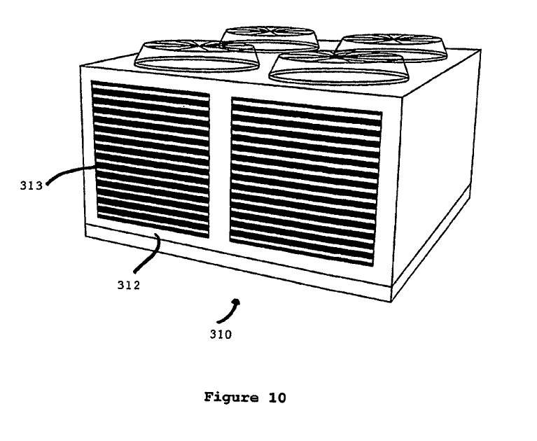

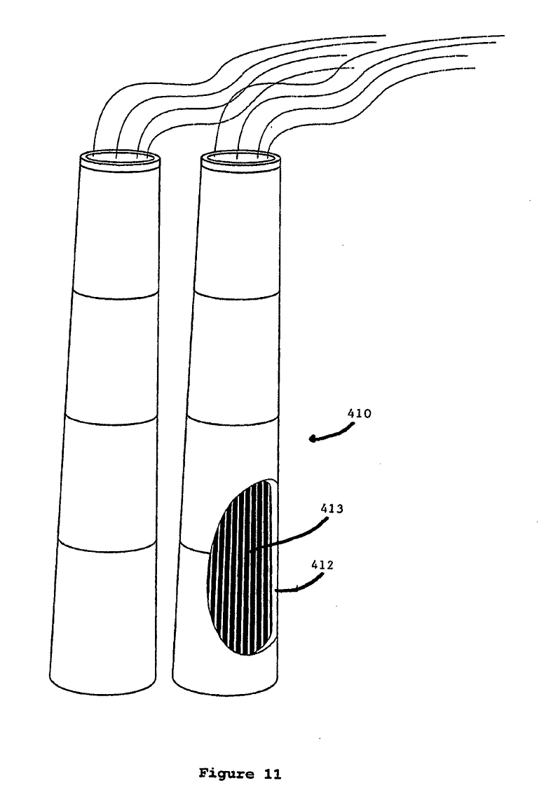

Referring now to FIGS. 8, 9, 10 and 11, other embodiments of the present invention are shown in the forms of a gas mask 110, an automobile exhaust 210, an air conditioning unit 310 and an exhaust stack 410. Each comprise a filter material 112, 212, 312, and 412 respectively, having bentonite disposed within a support 113, 213, 313, and 413 respectively.

The filter materials 112, 212, 312, and 412 are similar to the filter material 12, as are the supports 113, 213, 313, and 413 in respect of the support 13.

The present invention will now be illustrated through the following examples.

### Example 1

### Smoke Retention

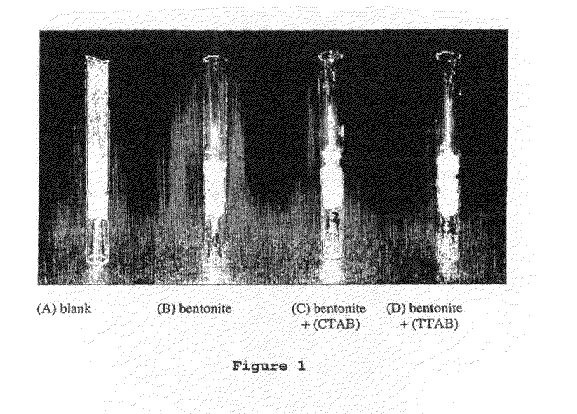

In an initial batch of experiments smoke was passed through various bentonite sorbenta and the organic compounds retained in the bentonite layer were extracted with hexane and assessed using GC/MS. These preliminary results showed distinct discoloration of the bentonite filter relative to the blank indicative of significant compound retention and the colour and degree of retention also varied with the sorbent (FIG. 1).

### Example 2

### Metal Ion Concentration (ICP-MS)

In this experiment the smoke of 1 or 3 cigarettes was bubbled through and collected in two 10% HNO₃ (20 ml) solutions connected in-line. These solutions were later combined, diluted (×2) with water and analysed by ICP-MS. The results shown in Table 1 clearly indicate that the use of a bentonite filter comprising 0.15 g sorbent (size, 75 sieve) packed into a glass tube as shown in FIG. 1A consistently increased the amount of target metal captured from cigarette smoke when using this collection technique. This suggests that bentonite is capable of extracting metals from the cigarette smoke.

TABLE 1
Selected metal concentration determined in cigarette
smoke by ICP-AES. Smoke collected 10% HNO₃ (40 ml).

| Sample | As | Cd | Cr | Pb | Cu |
|---|---|---|---|---|---|
| Designation | (μg L⁻¹) | (μg L⁻¹) | (μg L⁻¹) | (μg L⁻¹) | (μg L⁻¹) |
| No filter - 1 | <0.1 | <0.1 | 1.3 | 0.9 | 6.7 |
| smoked | | | | | |
| Bentonite filter - | 20.8 | 1.3 | 1.5 | 6.2 | 15.8 |
| 1 smoked | | | | | |
| No filter - 3 | 1.7 | 0.3 | 1.7 | 0.5 | 5.3 |
| smoked | | | | | |
| Bentonite filter - | 15.3 | 1.6 | 2.7 | 8.7 | 47.6 |
| 3 smoked | | | | | |

### Example 3

### Metal Ion Concentration (ICP-AES)

In this example the smoke of 1, 2 or 4 cigarettes was bubbled through and collected in 10% HNO₃ (10 ml) where the cigarettes had no filter, a commercial filter or a bentonite filter (0.1 g). The metal content of the acid solution was determined by Inductively Coupled Plasma Atomic Emission Spectroscopy (ICP-AES). However, of the four target metals initially proposed (As, Cd, Cr and Pb) only Pb was observed at consistently quantifiable levels using this technique (Table 2).

TABLE 2
Selected metal concentrations determined in
cigarette smoke by ICP-AES. Smoke collected 10% HNO₃
(10 ml).

| | Cu | Pb | Zn |
|---|---|---|---|
| Sample Designation | (mg L⁻¹) | (mg L⁻¹) | (mg L⁻¹) |
| No filter - 1 smoked | 0.042 | <0.045 | 0.143 |
| Commercial filter - 1 | <0.021 | <0.045 | 0.102 |
| smoked | | | |
| Bentonite filter - 1 | <0.021 | 0.114 | 0.024 |
| smoked | | | |
| No filter - 2 smoked | 0.025 | 0.073 | 0.046 |
| Commercial filter - 2 | <0.021 | 0.072 | 0.036 |
| smoked | | | |
| Bentonite filter - 2 | <0.021 | 0.083 | 0.013 |
| smoked | | | |
| No filter - 4 smoked | 0.026 | 0.151 | 0.222 |
| Commercial filter - 4 | <0.021 | 0.128 | 0.105 |
| smoked | | | |
| Bentonite filter - 4 | <0.021 | 0.129 | 0.020 |
| smoked | | | |

Quantifiable limits for target metals not listed above were: As (<0.047 mg L⁻¹); Cd (<0.014 mg L⁻¹) and Cr (<0.011 mg L⁻¹).

These results suggested that for Cu there was no significant effect of filter type on metal retention. While for Zn the bentonite filter substantially retained a significant amount of Zn relative to the commercial filter.

### Example 4

### Identification of Filter Retained Organic Compounds

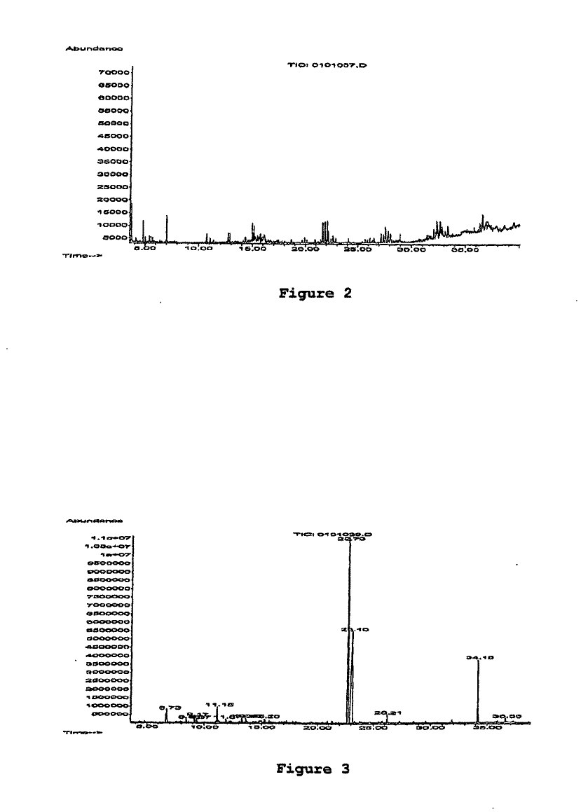

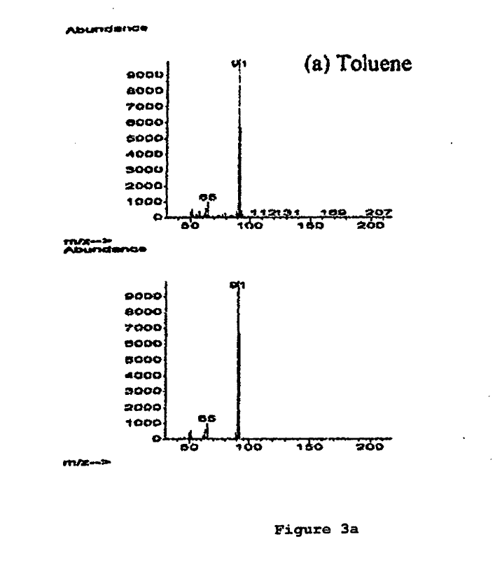

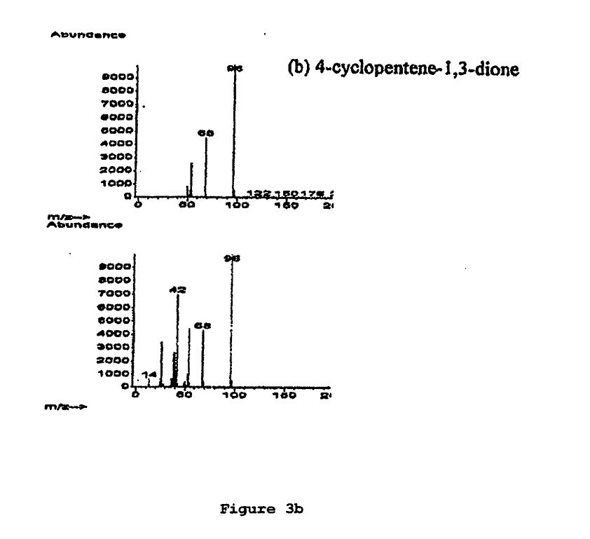

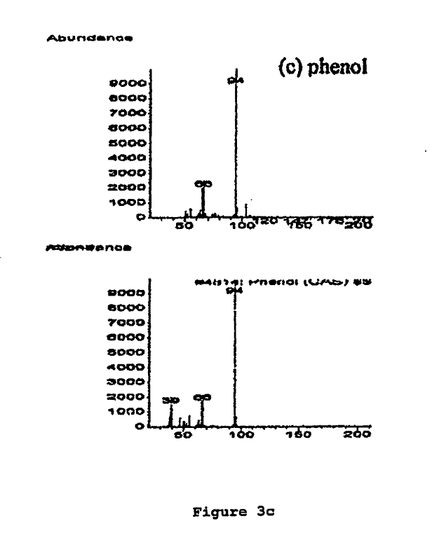

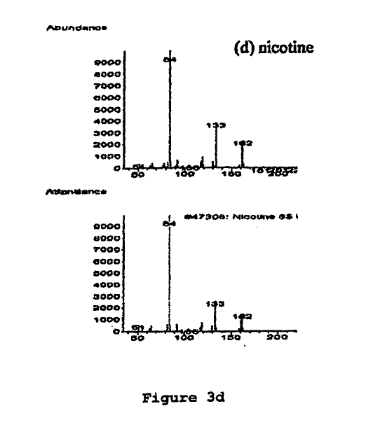

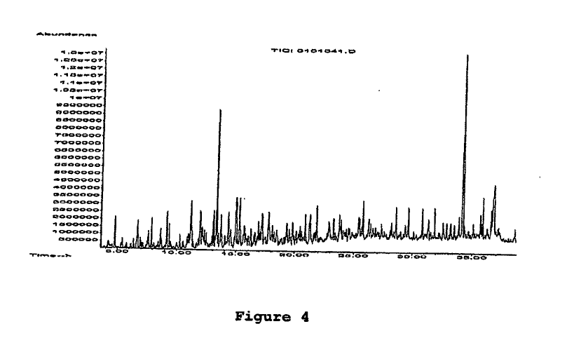

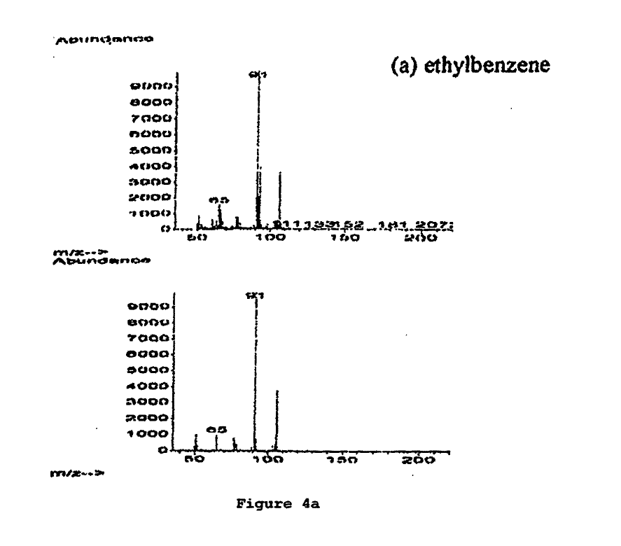

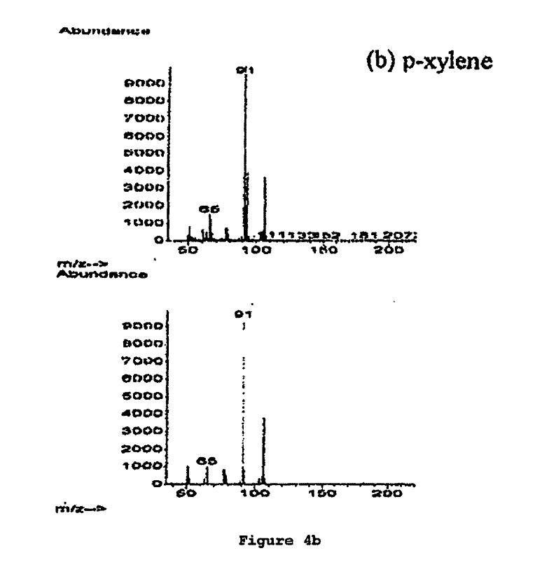

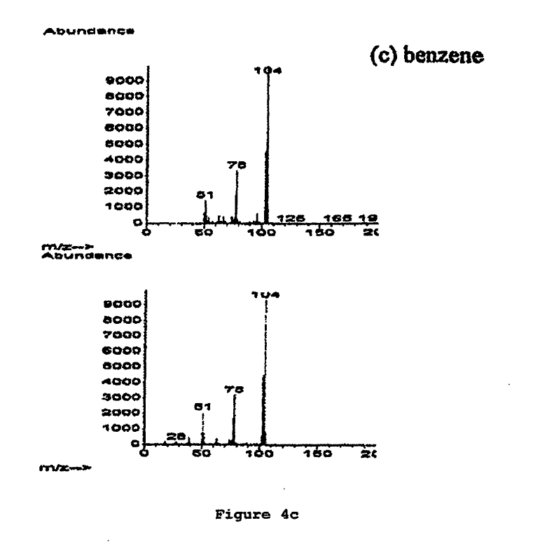

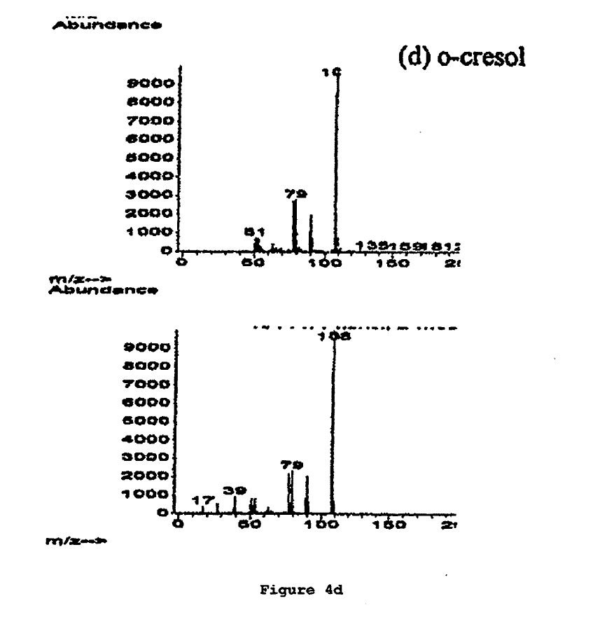

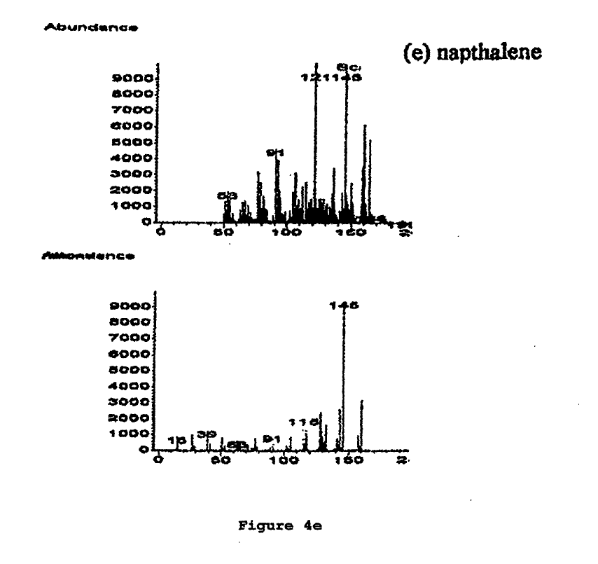

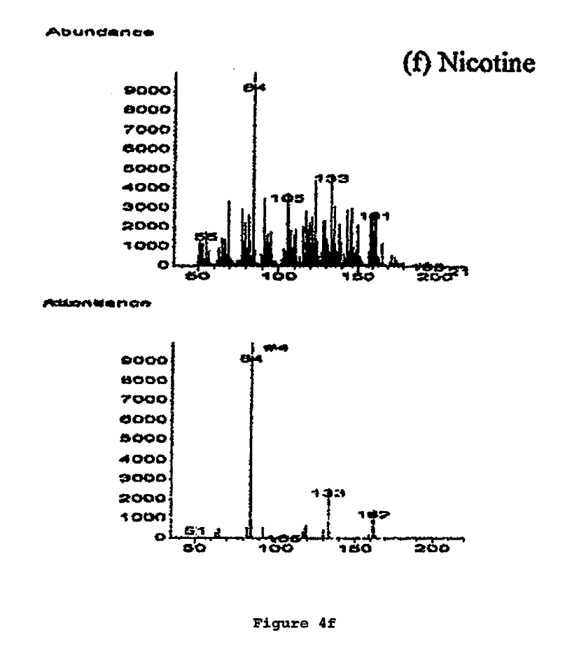

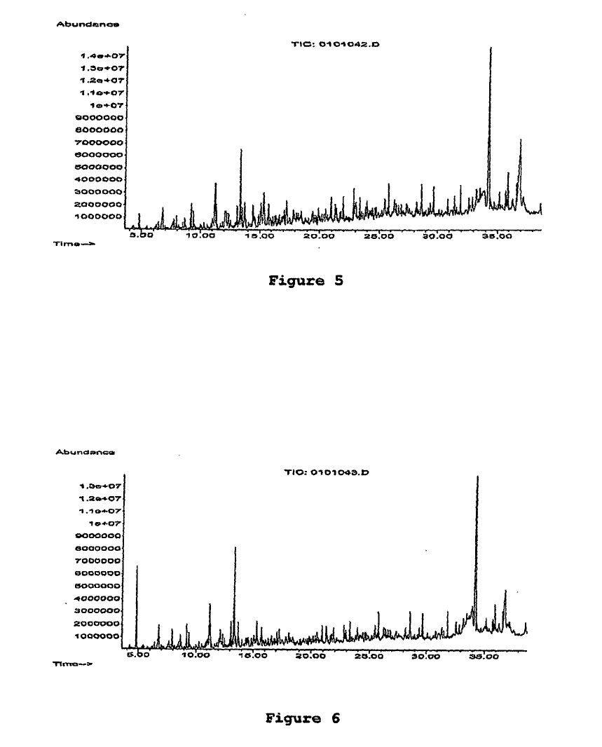

Cigarettes were obtained commercially (Peter Jackson (extra mild)) from Philip Morris Ltd., and the normal filters removed. Where a bentonite filter is used this comprises 0.15 g sorbent (size, 75 sieve) packed into a glass tube as shown in FIG. 1A. The smoke from one cigarette was passed through each new filter using a vacuum pump (flow rate near 25 ml/min). After the smoke had passed through the tube, the sorbent was eluted with hexane (1.5 ml) to extract retained organic compounds from sorbent. The extracted hexane solution was filtered and then directly injected into a GC/MS system for compound identification, which was an Agilent 6870 GC system coupled with 5973 MSD.
Typical Conditions used in GC/MS:
   DB-5; 30 m×0.53 mm, I.D. 0.5 μm; He: 1.2 ml/min
   Oven: 35° C. for 3 min, 4° C./min to 50° C., 5° C./min to 200° C.
   Total run: 39 min.
   Injector: splitless, 250, 1 μL.
   Detector: MJS, 300° C. transfer line, full scan at m/z 50-500.
The chromatogram of an “unsmoked” bentonite clay showed only a few compounds in low abundance (<15,000) after extraction with hexane (FIG. 2).
Hereafter, the term “smoked” shall refer to the passage of cigarette smoke through the filter and the term “unsmoked” shall simply refer to the absence of such a process.
Initially the commercially available filter was extracted after being “smoked”. The chromatogram indicated the retention of several organic compounds (FIG. 3).
The major compounds retained on the commercial filter included: nicotine, toluene, phenol, ethenone, limonene, furfurol, 4-cyclopentene-1.3-dione, 2-cyclopenten-1-one, 2-furancaboxaldehyde, 2,3-dimethylcyclopen-2en-1-one, phenol-2-methoxyl, triacetin and neophytadiene.
Identification of the organic compounds was based on comparison of the MSS fragmentation patterns of the extracted sample with those available in the spectral library (as shown in FIG. 3a-d).
The unmodified bentonite (FIG. 1b) was also “smoked” and extracted with hexane.
In comparison to the few organic compounds retained on the commercial filter more than 200 organic compounds of high concentration (high abundance) were extracted from the smoked unmodified bentonite filter (FIG. 4).
The main organic compounds included toluene, ethylbenzene, p-xylene, L-leucine, benzene, 2,4-hexadiene, ethanone, 2-furancaboxaldehyde, phenol, limonene, o-cresol, phenol-2-methoxyl, p-ethylphenol, 1-H-indole, naphthalene, nicotine, benzenemethanol, solanone, farnesyl acetone B, megastigmatrienone, neophytradinen, triacetin, nicotyrine, neophytadiene.
Bentonite modified with CTAB (FIG. 1C) was also “smoked” and extracted with hexane.
As was observed with the natural (unmodified) bentonite filter the CTAB modified filter also retained more than 200 organic compounds in high concentrations (high abundance) after the passage of cigarette smoke (FIG. 5).
Bentonite modified with TTAB (FIG. 1C) also retained more than 190 organic compounds in high concentrations (high abundance) after the passage of cigarette smoke through the filter and extraction with hexane (FIG. 6).
These examples clearly demonstrate that bentonite filters are capable of retaining significantly greater amounts of organic compounds (FIGS. 4, 5 and 6) than conventional filters (FIG. 3).
The physical characteristics of the main organic compounds retained on the three different sorbents tested in this study are summarized in Table 3.
In general, the amount of any given organic compound detected on an organobentonite (modified) filter was less than that of the natural bentonite (unmodified) filter. This may have resulted from changes in the surface of bentonite upon modification and the strong interaction between the surface sites of modified bentonite and organic compounds making extraction of bound compounds more difficult.

TABLE 3
Retention time and abundance of common organic
compounds extracted from modified and unmodified bentonite
filters after passing cigarette smoke through the filter³.

| Organic | Retention | Peak Area | | |
|---|---|---|---|---|
| Residue | Time (min) | Bentonite | Bentonite | Bentonite |
| Toluene | 4.79 | 18831425 | 31833390 | 118415347 |
| Ethybenzene | 7.63 | 69085651 | 40888234 | 25917724 |
| p-xylene | 7.70 | 58745526 | 37820101 | 47580980 |
| Benzene | 8.62 | 37581317 | 26518374 | 30191456 |
| Ethanone | 9.37 | 51488349 | 50894194 | 38025804 |
| Phenol | 13.34 | 155339995 | 79616109 | 42157124 |
| Limonene | 13.33 | 306646809 | 176184846 | 236034048 |
| o-cresol | 14.35 | 122567585 | 83782696 | 34256648 |
| Naphthalene | 21.77 | 26956439 | 46887684 | 24155369 |
| Nicotine | 22.78 | 101354876 | 105217012 | 5618121 |
| Neophytadiene | 34.20 | 642406898 | 803969782 | 715476203 |

a - 0.15 g of sorbent loaded

In the claims which follow and in the preceding description of the invention, except where the context requires otherwise due to express language or necessary implication, the word “comprise” or variations such as “comprises” or “comprising” is used in an inclusive sense, ie. to specify the presence of the stated features but not to preclude the presence or addition of further features in various embodiments of the invention.

It is to be clearly understood that although prior art publication(s) are referred to herein, this reference does not constitute an admission that any of these documents forms part of the common general knowledge in the art in Australia or in any other country.

### REFERENCES

The contents of the following documents are incorporated hereby by reference:
D. Hoffman, I. Hoffman, J. Toxi & Environ. Health, 1997, 50, 307-364.
C. J. Smith, S. D. Livingston, D. J. Doolittle, Food and Chem. Toxi., 1997, 35, 1107-1130.
G. Deliconstantinos, V. Villiotou, J. C. Stavrides, Anticaner Res., 1994, 2717.
R. D. Safaev, D. G. Zaridze, D. Hoffman, K. Brunnemann, Y. Liu. Eksperimentalnaia Onkologia, 1995, 17, 71.
R. Naseem, S. S. Tahir, Wat. Res., 2001, 3982.
S. A. Boyd, M. M. Mortland, C. T. Chiou, Soil Sci. Am. J. 1988.
Y. H. Shen, Chemosphere, 2001, 989.
M. C. Irene, X. Y. Yang, Environ. Sol. Technol., 2001, 35, 620.
L. H. Zhu, B. L. Chen, Environ. Sci. Technol., 2000, 34, 2997.
J. J. Deitsch, J. A. Smith, M. B. Arnold, J. Bolus, Environ. Sci. Technol., 1998, 32, 3169.

1. A filter material for removing toxins and/or environmental contaminants from a body of gas produced from high temperature combustion, comprising bentonite disposed within a support arranged so as to allow contact between the body of gas and the bentonite, wherein at least some of the bentonite is modified by a chemical or physical treatment.

2. A filter material as claimed in claim 1, wherein the bentonite is in comminuted, granular and/or powdered form.

3. A filter material as claimed in claim 1, wherein the bentonite is a calcium bentonite.

4. A filter material as claimed in claim 1, wherein at least some of the bentonite is modified by a chemical or physical treatment.

5. A filter material as claimed in claim 1, wherein the bentonite comprises a mixture of modified and unmodified bentonite.

6. A filter material as claimed in claim 2, wherein the surface of at least some of the bentonite particles is modified by introducing a surface active agent.

7. A filter material as claimed in claim 1, wherein at least some of the bentonite is modified by introducing one or more surfactants to decrease its hydrophilicity.

8. A filter material as claimed in claim 6, wherein the surfactant is a cationic surfactant.

9. A filter material as claimed in claim 6, wherein the surfactant is a quaternary ammonium surfactant of general formula (CH₃)₃NR⁺.

10. A filter material as claimed in claim 6, wherein the surfactant is cetyltrimethyl bromide (CTAB) and/or cetyltrimethyl ammonium tosylate (TTAB).

11. A filter material as claimed in claim 1, wherein the support comprises a polymeric matrix.

12. A cigarette, tobacco pipe or cigar comprising a filter material as claimed in claim 1.

13. A gas mask comprising a filter material as claimed in claim 1.

14. An air conditioning unit comprising a filter material as claimed in claim 1.

15. An automobile exhaust comprising a filter material as claimed in claim 1.

16. An exhaust stack comprising a filter material as claimed in claim 1.

17. A method of removing toxins and/or environmental contaminants from a body of gas produced from high temperature combustion, comprising contacting the body of gas with bentonite, wherein at least some of the bentonite is modified by a chemical or physical treatment.
